(19) United States
(12) Patent Application Publication
(10) Pub. No.: US 2023/0330858 A1
(43) Pub. Date: Oct. 19, 2023

(54) FINE-GRAINED INDUSTRIAL ROBOTIC ASSEMBLIES

(71) Applicant: Siemens Corporation, Washington, DC (US)

(72) Inventors: Eugen Solowjow, Berkeley, CA (US); Juan L. Aparicio Ojea, Moraga, CA (US); Avinash Kumar, Munich (DE); Matthias Loskyll, Neumarkt (DE); Gerrit Schoettler, Berkeley, CA (US)

(73) Assignee: Siemens Corporation, Washington, DC (US)

(21) Appl. No.: 18/044,242

(22) PCT Filed: Sep. 9, 2021
(86) PCT No.: PCT/US2021/049544

§ 371 Date: Mar. 7, 2023

Related U.S. Application Data
(60) Provisional application No. 63/075,916, filed on Sep. 9, 2020.

(51) Int. Cl. B25J 9/16

(52) U.S. Cl. CPC B25J 9/1687; B25J 9/1697; B25J 5/007

(57) ABSTRACT

In an example aspect, a first object (e.g., an electronic component) is inserted by a robot into a second object (e.g., a PCB). An autonomous system can capture a first image of the first object within a physical environment. The first object can define a mounting interface configured to insert into the second object. Based on the first image, a robot can grasp the first object within the physical environment. While the robot grasps the first object, the system can capture a second image of the first object. The second image can include the mounting interface of the first object. Based on the second image of the first object, the system can determine a grasp offset associated with the first object. The grasp offset can indicate movement associated with the robot grasping the first object within the physical environment. The system can also capture an image of the second object. Based on the grasp offset and the image of the second object, the robot can insert the first object into the second object.

### CROSS-REFERENCE TO RELATED APPLICATIONS

This application claims the benefit of U.S. Provisional Application Serial No. 63/075,916 filed on Sep. 9, 2020, the disclosure of which is incorporated herein by reference in its entirety.

### BACKGROUND

Artificial Intelligence (AI) and robotics are a powerful combination for automating tasks inside and outside of the factory setting. Autonomous operations in dynamic environments may be applied to mass customization (e.g., high-mix, low-volume manufacturing), on-demand flexible manufacturing processes in smart factories, warehouse automation in smart stores, automated deliveries from distribution centers in smart logistics, and the like. In order to perform autonomous operations, such as grasping and manipulation, robots may learn skills through exploring the environment. In particular, for example, robots might interact with different objects under different situations. Three-dimensional (3D) reconstruction of an object or of an environment can create a digital twin or model of a given environment of a robot, or of a robot or portion of a robot, which can enable a robot to learn some skills efficiently and safely.

Convention feedback control methods (or convention control) can often solve various types of robot control problems efficiently by capturing the structure with explicit models, such as rigid body equations of motion. It is recognized herein, however, that control problems in modern manufacturing often involve contacts and friction, which can be difficult to capture with first-order physical modeling. Thus, applying conventional control in modern industrial robotic manufacturing case can, in some cases, result in brittle and inaccurate controllers that have to be manually tuned for deployment.

As described above, reinforcement learning (RL) can be implemented for a robot controller to learn motions from interactions with the environment. It is recognized, however, that current RL approaches are generally limited to tasks that involve coarse motions, such as opening a door or pushing an object.

### BRIEF SUMMARY

Embodiments of the invention address and overcome one or more of the described-herein shortcomings or technical problems by providing methods, systems, and apparatuses for performing delicate or fine-grained robotic tasks, such as delicate grasping and insertion tasks. By way of example, in accordance with various embodiments described herein, a robot can perform fine-grained grasping and inserted tasks so as to assemble a printed circuit board (PCB).

In an example aspect, a first object (e.g., an electronic component) is inserted by a robot into a second object (e.g., a PCB). An autonomous system can capture a first image of the first object within a physical environment. The first object can define a mounting interface configured to insert into the second object. Based on the first image, a robot can grasp the first object within the physical environment. While the robot grasps the first object, the system can capture a second image of the first object. The second image can include the mounting interface of the first object. Based on the second image of the first object, the system can determine a grasp offset associated with the first object. The grasp offset can indicate movement associated with the robot grasping the first object within the physical environment. The system can also capture an image of the second object. Based on the grasp offset and the image of the second object, the robot can insert the first object into the second object.

Capturing the first image of the first object can include capturing, by a first camera, the first image from an overhead perspective of the first object. Further, the robot can define an end effector configured to grasp objects. Capturing the second image of the first object can include positioning the first object, by the robot, over a second camera. The second camera can capture the second image from a perspective opposite the overhead perspective captured by the first camera. In another example, the system can obtain a position of the end effector, wherein the robot inserting the first object into the second object is further based on the position of the end effector. The system can be configured to monitor and control forces associated with the end effector as the robot inserts the first object into the second object. After inserting the first object into the second object so as to define a successful insertion, the system can store the second image and the position of the end effector during the successful insertion. The system can also be configured to detect the successful insertion. In some examples, responsive to detecting the successful insertion, a success signal is sent to a reinforcement learning module so as to train the reinforcement learning module to learn an insertion path conditioned on the grasp offset and a location defined by the second object relative to the robot.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example system that includes an autonomous machine in an example physical environment that includes various objects including a printed circuit board (PCB) and electronic components configured to be inserted into the PCB, in accordance with an example embodiment.

FIG. 2 illustrates an example neural network that can part of the system illustrated in FIG. 1, in accordance with an example embodiment.

FIG. 3 is a flow diagram that illustrates an example operation that can be performed by an autonomous system in accordance with an example embodiment.

FIG. 4 illustrates a computing environment within which embodiments of the disclosure may be implemented.

### DETAILED DESCRIPTION

It is recognized herein that, with respect to delicate or fine-grained grasping and insertion tasks, such as tasks involved in a printed circuit board (PCB) assembly, current approaches lack capabilities. For example, conventional control methods generally cannot perform fine-grained tasks with generic robot hardware, such as low-cost collaborative robots (cobots) and two-finger grippers. Further, it is recognized herein that measurements of insertion locations and preprogramming of how to grasp components are subject to uncertainties and are prone to errors. Such uncertainties and errors can limit, or render impossible, part insertions that are based on moving the part to a goal position according to a preprogrammed motion. Embodiments described herein, however, can perform grasping and insertion tasks that have uncertainty or require flexibility. In particular, for example, a reinforcement learning (RL) module can control a robot so that the robot can perform delicate insertion tasks that require fine-grained motions, such as tasks involved with assembling a printed circuit board (PCB), among others.

By way of further background, it is also recognized herein that robotic insertion tasks in industry are generally rigidly engineered such that uncertainty and flexibility are minimized, for example, by using fixtures and preprogrammed motions. It is further recognized herein that through-hole technology (THT) insertions in electronics production are often a manual task, due to the technical challenges described herein related to robotic PCB assemblies. In accordance with various embodiments described herein, a system can perform RL so that robots within the system can perform delicate insertion tasks that require fine-grained motions. Such delicate tasks are described herein through examples of industrial robots assembling a PCB, though it will be understood that embodiments are not limited to PCB assemblies, and all such other applications of fine-grained robotic motions or assemblies are contemplated as being within the scope of this disclosure.

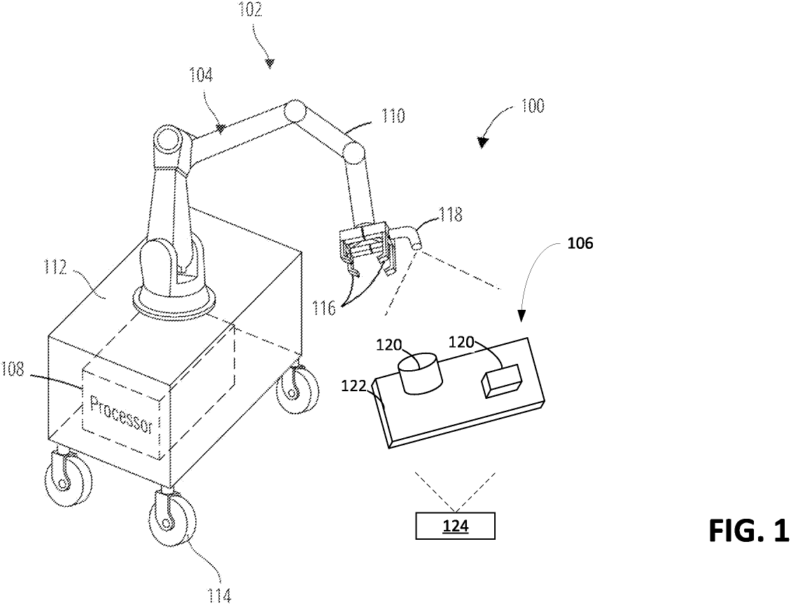

Referring now to FIG. 1, an example industrial or physical environment 100 is shown. As used herein, a physical environment can refer to any unknown or dynamic industrial environment. A reconstruction or model may define a virtual representation of the physical environment 100 or one or more objects 106 within the physical environment 100. By way of example, the objects can include one or more electronic components or parts 120 (e.g., capacitors, transistors, integrated circuits, etc.) and a printed circuit board (PCB) 122 configured to receive electronic components 120. The physical environment 100 can include a computerized autonomous system 102 configured to perform one or more manufacturing operations, such as assembly, transport, or the like. The autonomous system 102 can include one or more robot devices or autonomous machines, for instance an autonomous machine or robot device 104, configured to perform one or more industrial tasks, such as bin picking, grasping, insertion, or the like. The system 102 can include one or more computing processors configured to process information and control operations of the system 102, in particular the autonomous machine 104. The autonomous machine 104 can include one or more processors, for instance a processor 108, configured to process information and/or control various operations associated with the autonomous machine 104. An autonomous system for operating an autonomous machine within a physical environment can further include a memory for storing modules, for instance deep reinforcement learning (RL) module 302. The processors can further be configured to execute the modules so as to process information and generate models based on the information. It will be understood that the illustrated environment 100 and the system 102 are simplified for purposes of example. The environment 100 and the system 102 may vary as desired, and all such systems and environments are contemplated as being within the scope of this disclosure.

Still referring to FIG. 1, the autonomous machine 104 can further include a robotic arm or manipulator 110 and a base 112 configured to support the robotic manipulator 110. The base 112 can include wheels 114 or can otherwise be configured to move within the physical environment 100. The autonomous machine 104 can further include an end effector 116 attached to the robotic manipulator 110. The end effector 116 can include one or more tools configured to grasp and/or move objects 106. Example end effectors 116 include finger grippers or vacuum-based grippers. The robotic manipulator 110 can be configured to move so as to change the position of the end effector 116, for example, so as to place or move objects 106 within the physical environment 100. The system 102 can further include one or more cameras or sensors, for instance a first or three-dimensional (3D) point cloud camera 118, configured to detect or record objects 106 within the physical environment 100. The camera 118 can be mounted to the robotic manipulator 110 or otherwise configured to generate a 3D point cloud of a given scene, for instance the physical environment 100. Alternatively, or additionally, the one or more cameras of the system 102 can include one or more standard two-dimensional (2D) cameras that can record or capture images (e.g., RGB images or depth images) from different viewpoints. Those images can be used to construct 3D images. For example, a 2D camera can be mounted to the robotic manipulator 110 so as to capture images from perspectives along a given trajectory defined by the manipulator 110.

The system 102 can further include a second or bottom camera 124 configured to record objects 106 while the object is grasped by the end effector 116. In particular, the camera 124 can be disposed with the workspace of the robot 104, such that the robot 104 can grasp a given object and hold the object over the camera 124, thereby enabling the camera 124 to capture an image of the bottom of the object. By way of example, before inserting one of the electronic components 120 in the PCB 122, the end effector 116 can hold the electronic component 120 over the camera 124. The camera 124 can capture an image of the electronic component 120, for instance the bottom of the electrical component 120. In particular, the bottom of the electronic component 120 can define an insertion or mounting interface of the electrical component that is configured to be inserted into the PCB 122. Thus, the camera 124 can be configured to capture images of the insertion or mounting interface of electronic components 120. The second camera 124 can be positioned opposite the first camera 118, such that the cameras 118 and 124 can capture opposite perspectives of a given object. In an example, the first camera 118 captures a first image of the electronic component 120 from an overhead perspective, and the second camera 122 captures a second image of the electronic component 120, in particular the mounting interface of the electronic component 120, from a perspective opposite the overhead perspective captured by the camera 118.

With continuing reference to FIG. 1, in an example, one or more cameras can be positioned over the autonomous machine 104, or can otherwise be disposed so as to continuously monitor any objects within the environment 100. For example, when an object, for instance one of the objects 106, is disposed or moved within the environment 100, the camera 118 can detect the object.

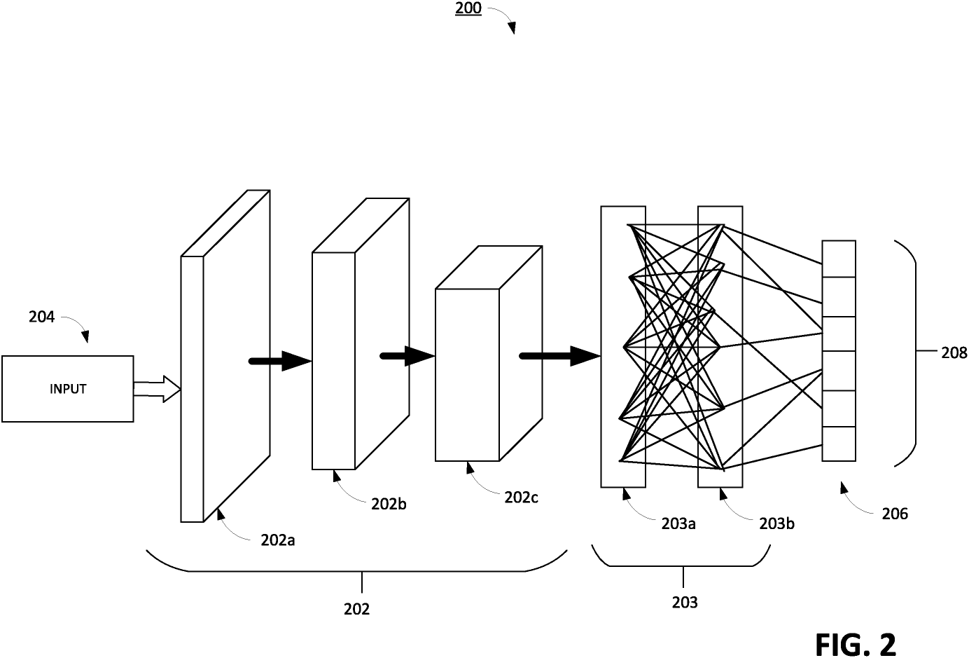

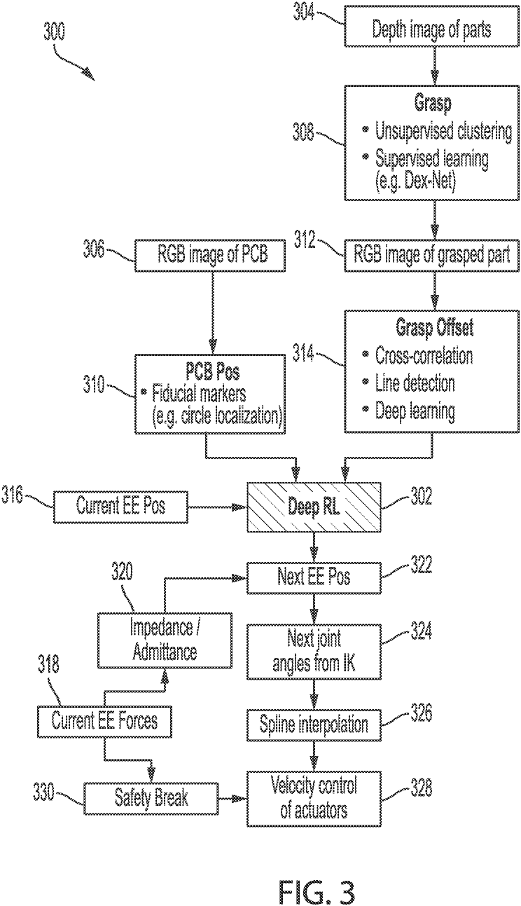

Referring also to FIGS. 2 and 3, as described above, the robot device 104 and/or the system 102 can include one or more neural networks configured to learn various objects so as to identify grasp points (or locations) of various objects and insertion positions of various objects that can be found within various industrial environments. For example, the system 102 can include the deep reinforcement learning module 302 that defines one or more neural network models, for instance an example system or neural network model 200.

After the neural network 200 is trained, for example, images of objects can be sent to the neural network 200 by the robot device 104 for classification, for instance classification of grasp locations, pose estimations, or grasp offsets. The example neural network 200 includes a plurality of layers, for instance an input layer 202a configured to receive an image, an output layer 203b configured to generate class or output scores associated with the image or portions of the image. For example, the output layer 203b can be configured to label each pixel of an input image with a grasp affordance metric. In some cases, the grasp affordance metric or grasp score indicates a probability that the associated grasp will be successful. Success generally refers to an object being grasped and carried without the object dropping. The neural network 200 further includes a plurality of intermediate layers connected between the input layer 202a and the output layer 203b. In particular, in some cases, the intermediate layers and the input layer 202a can define a plurality of convolutional layers 202. The intermediate layers can further include one or more fully connected layers 203. The convolutional layers 202 can include the input layer 202a configured to receive training and test data, such as images. In some cases, training data that the input layer 202a receives includes synthetic data of arbitrary objects. Synthetic data can refer to training data that has been created in simulation so as to resemble actual camera images. The convolutional layers 202 can further include a final convolutional or last feature layer 202c, and one or more intermediate or second convolutional layers 202b disposed between the input layer 202a and the final convolutional layer 202c. It will be understood that the illustrated model 200 is simplified for purposes of example. In particular, for example, models may include any number of layers as desired, in particular any number of intermediate layers, and all such models are contemplated as being within the scope of this disclosure.

The fully connected layers 203, which can include a first layer 203a and a second or output layer 203b, include connections between layers that are fully connected. For example, a neuron in the first layer 203a may communicate its output to every neuron in the second layer 203b, such that each neuron in the second layer 203b will receive input from every neuron in the first layer 203a. It will again be understood that the model is simplified for purposes of explanation, and that the model 200 is not limited to the number of illustrated fully connected layers 203. In contrast to the fully connected layers, the convolutional layers 202 may be locally connected, such that, for example, the neurons in the intermediate layer 202b might be connected to a limited number of neurons in the final convolutional layer 202c. The convolutional layers 202 can also be configured to share connections strengths associated with the strength of each neuron.

Still referring to FIG. 2, the input layer 202a can be configured to receive inputs 204, for instance an image 204, and the output layer 203b can be configured to return an output 206. In some cases, the input 204 can define a depth frame image of an object captured by one or more cameras pointed toward the object, such as the cameras of the system 102. The output 206 can include one or more classifications or scores associated with the input 204. For example, the output 206 can include an output vector that indicates a plurality of scores 208 associated with various portions, for instance pixels, of the corresponding input 204.

The input 204 is also referred to as the image 204 for purposes of example, but embodiments are not so limited. The input 204 can be an industrial image, for instance an image that includes a part, a PCB, or electronic component that is classified so as to identify a grasp region for an assembly or insertion. It will be understood that the model 200 can provide visual recognition and classification of various objects and/or images captured by various sensors or cameras, and all such objects and images are contemplated as being within the scope of this disclosure.

Referring in particular to FIG. 3, the autonomous system can perform various operations 300 in accordance with various embodiments. In some examples, the electronic components 120 and the PCB 122 can be arbitrarily placed within the physical environment 100. Thus, regardless of the initial position of the electronic components 120 and the PCB 122, the system 102 can grasp the components 120 and make adjustments to address uncertainties in perception and grasp, so as to insert the mounting interface of the components 120 into the PCB 122. In particular, one or more images of an object, for instance one of the electronic components 120, can be captured. In an example, a depth image 304 of a particular part or electronic component 120 can be captured by the camera 118. In some cases, at 308, the pose (e.g., position and orientation) of the electrical component can be estimated or computed by neural network 200, based on the image 304 of the electrical component or part 120 that defines the input 204. Thus, the system 102 can determine a grasp location based on the image 304. One or more images, for instance RGB images 306, can be captured of the PCB 122. For example, one or more images of the PCB 122 can also be captured by the camera 118 or an alternative overhead camera positioned to monitor the workspace of the robot device 104. In some examples, at 310, based on the image 306, the pose (e.g., position and orientation) of the PCB 122 can be estimated or computed by the neural network 200, such that the image 306 of the PCB 122 defines the input 204. At 310, the PCB 122 can be localized so that various features are detected. For example, fiducial markers, for instance in the form of circles, can be located on the PCB 122, and can be detected at 310. In some cases, the system 102 is calibrated such that the position and orientation of the PCB 122 within the physical environment 100 (or within a coordinate system of the robot 104) can be inferred from the pixels (which represent positions) of the detected features of the PCB 122.

Additionally, at 308, the depth images 304 can define the basis for grasp calculations. By way of example, and without limitation, grasping calculations can be based on deep learning (e.g., Dex-Net). Alternatively, or additionally, the grasping calculations can be based on unsupervised clustering algorithms. The electronic component 120, which can define a rectangular or round shape, among others, can be grasped by the robot 104, in particular the end effector 116, in accordance with the grasp calculations performed at 308. The grasp calculations can also be based on a grasp policy. By way of example, and without limitation, a grasp policy may indicate that the center of opposed sides of the electrical component 120 is grasped by finger grippers. It is recognized herein that the grasp position of the electrical component 120 relative to the end effector can change after the electrical component is grasped due to slip, friction, motions, or the like. Such a change in the grasp position of the electrical component 120 relative to the end effector 116 can define the grasp offset. Thus, the grasp offset can indicate movement associated with the robot 104 grasping the electronic component 120 within the physical environment 100. It is recognized herein that the grasp offset can limit or prevent robots from performing fine-grained motions such as inserting the electrical component 120 in the PCB 122. As further described herein, based on an image of the mounting interface of the electronic component 120 that can be captured by the second camera 124, the system 102 can determine the grasp offset associated with the electronic component.

Thus, to address the grasp offset or reduce grasp uncertainties, while grasping the electronic component 120, the robot 104 can position the electrical component over the camera 124. The camera 124 can capture an image 312, for instance an RGB image, of the electronic component 120 while the electronic component 120 is positioned over the camera 124. In particular, the image 312 can include the bottom or mounting interface of the electronic component 120. Based on the image 312, at 314, the system 102 can calculate the grasp offset. In some cases, the grasp offset defined by the camera image 312 can be calculated relative to a centered grasp. In an example, when the grasped electronic component 120 defines a rectangular part, the grasp offset can define a translation along a longitudinal direction, and the translation can be calculated by comparing the image 312 of the electronic component in the grasped position to a calibration image in which the electronic component is centered or otherwise calibrated along the longitudinal direction. In another example, when the grasped electronic component 120 defines a circular or round part, the grasp offset can define a rotation. Further, the mounting interface or bottom of the electronic component can define pins configured to be inserted into the PCB 122. Thus, the rotation that defines the grasp offset can be determined by performing line detection, wherein the lines are defined by the pins.

Alternatively, or additionally, the image 312 can be fed into a deep neural network, for instance the neural network 200, which can estimate or determine the grasp offset. In some cases, the deep RL module 302, which can define one or more neural networks 200, is configured to determine the grasp offset and/or the features of PCB 122, at 310 and 312, respectively. To determine the grasp offset, the RL module 201 can train a neural network in a supervised fashion.

In an example, the RL module 302 can perform real-world training by performing grasps that define random grasp offsets of electrical components 120. In an example, an insertion policy can define a spiral search for inserting the electrical components such that after each successful insertion, the insertion location associated with the successful insertion is stored with the associated image of the bottom of the part. The insertion location can indicate the position of a given electronic component 120 relative to the PCB 122, such that associated image includes the mounting interface of the given electronic component 120. In another training example, the objects can be modeled in a simulation and domain randomization that can be used to generate large amounts of labelled training data.

With continuing reference to FIG. 3, the RL module 302 can receive or otherwise obtain the current position of the end effector 116. Based on the current position of the end effector 116 and the grasp offset that is predicted or determined at 314, the RL module 310 can determine or update a location of the end effector 116 for insertion of the electrical component 120 into the PCB 122. Based on the updated location, the RL module 302 can instruct or command the robot 104 to insert the electrical component 120, in particular the pins of the mounting interface of the electrical component 120, into the PCB 122. In particular, the RL module 302 can define a deep RL policy that is trained in the fragile environments, for instance the environment 100. Outputs of the policy, and thus outputs of the RL module 302, can include relative positions and orientation of the end effector 116. Thus, the RL module 302 can generate a new or subsequent position 322 of the end effector 116. Without being bound by theory, such outputs can enable a straight-forward implementation of safety constraints and a seamless transfer of the policy between different robots or between simulation and real-world environments.

In particular, for example, the system 102 can include sensors or accelerometers configured to measure forces 318 at the end effector 116. The system 102 can use measurements of the forces 318 at the end effector 116 for impedance control (at 320). In particular, at 320, the system 102 can set a limit that defines a maximum force that is applied to the PCB 122, so that damage to the PCB 122 is avoided. Additionally, at 320, the system 102 can use the measurements of the forces 318 for admittance control. In particular, for example, the robot 104 can be instructed to apply a constant downward force toward the PCB board 122, so as to reduce the dimension of the deep RL action space. In some cases, the system 102 does not need to learn the vertical component of the motion because the policy enforces a constant downward force that presses on the electronic part 120 that is being inserted.

Still referring to FIG. 3, after the system 102, in particular the deep RL module 302, computes the new position of the end effector 116 (at 322), the system 102 can calculate desired joint angles, for instance by using inverse kinematics, at 324. The system 102 can define computational limits that set an upper bound on the frequency at which new joint angles can be calculated. To smooth the movement of the robot, at 326, a spline interpolation can be performed between the current and the desired joint angles. At 328, in some examples, the system 102 can use the derivative of the spline to command the joint actuators in velocity mode at a high frequency. In some cases, commanding the joint actuators in velocity mode can result in superior precision as compared to control in position mode. In some examples, an upper limit on the joint velocity and a regular measurement of the end-effector forces 318 can ensure a safe behavior of the robot 104. Thus, at 330, in various examples, if a motion or action is outside of a defined safety envelope (e.g., forces 318 are above a threshold), the robot 104 can stop operation and inform an operator (e.g., via a visual or audio rendering) of the safety issue.

With continuing reference to FIG. 3, the deep RL policy can be trained at the RL module 302 to use the most efficient insertion path from grasp to insertion. The path can be conditioned on the estimated grasp offset (at 314) and the estimated PCB location relative to the robot 104 (at 310). An example deep RL algorithm that can be performed is Soft Actor-Critic, which uses a stochastic policy so as to learn the probability distribution of the most promising control actions, though it will be understood that embodiments are not so limited. As a reward function, in some cases, a sparse success signal can be transmitted. The success signal can be obtained by the RL module 302 by detecting the insertion of the pins of the electrical component 120. Such a detection can be performed by comparing the robot’s internal position measurement with a threshold in the vertical (or downward) direction. Alternatively, or additionally, the system 102 can include a camera positioned so as to monitor a slit defined between the mounting interface of the electrical component 120 and the top or mounting surface of the PCB 122. The slit can decrease in size (or close) as the electrical component 120 is inserted into the PCB 122 until the mounting interface of the electrical component 120 abuts, or is supported by, the top surface of the PCB 122. As the slit decreases in size, a brightness value associated with the slit can decrease. In some examples, the camera can monitor the brightness value of the pixels associated with the slit. Further, the RL module 302 can compare the brightness value to a predetermined threshold, so as to identify a successful insertion when the brightness value is below the predetermined threshold. By way of yet another example, the camera can capture an image of the electrical component 120 mounted to the PCB 122, and the image can be compared to a goal image so as to determine whether the electrical component is successfully inserted into the PCB 122.

In some cases, the training can be accelerated by performing boosting, which can lead the focuses toward the weaknesses of the policy. Boosting can be performed, for example, by requiring that the RL module 302 performs an insertion successfully a predetermined number of times (e.g., five) before the grasp and PCB locations are updated. Similarly, the policy can stipulate a number of failed attempts that result in a particular insertion being delayed. By way of example, for every five failed insertion attempts, the policy might require that the insertion is solved another time. Without being bound by theory, embodiments described above can define an optimization toward correcting unpredictable real-world errors, thereby achieving efficient, non-feedback insertion of highly sensitive PCB components.

Thus, as described herein, embodiments can address uncertainties in grasping, pose estimation, actuation, and the like, which can arise in flexible insertion use cases. It is recognized herein that current approaches often rely on specialized fixtures and end-effectors to reduce these uncertainties by design, which can add to cost as compared to the system 102 that does not require such fixtures. Further, without being bound by theory, the system 102, in particular the RL module 302, can learn to insert components into a PCB in a similar way as humans might do it. That is, the system 102 can follow a search pattern that can be adapted until the system feels the success. Further, rigidly engineered systems use position control to arrive at a predefined position, however, due to the described-herein uncertainties, the control system might think it arrived at the desired insertion position without the part being inserted. Embodiments described herein address that technical problem, among others.

As described herein, a first object (e.g., an electronic component) is inserted by a robot into a second object (e.g., a PCB). An autonomous system can capture a first image of the first object within a physical environment. The first object can define a mounting interface configured to insert into the second object. Based on the first image, a robot can grasp the first object within the physical environment. While the robot grasps the first object, the system can capture a second image of the first object. The second image can include the mounting interface of the first object. Based on the second image of the first object, the system can determine a grasp offset associated with the first object. The grasp offset can indicate movement associated with the robot grasping the first object within the physical environment. The system can also capture an image of the second object. Based on the grasp offset and the image of the second object, the robot can insert the first object into the second object.

Capturing the first image of the first object can include capturing, by a first camera, the first image from an overhead perspective of the first object. Further, the robot can define an end effector configured to grasp objects. Capturing the second image of the first object can include positioning the first object, by the robot, over a second camera. The second camera can capture the second image from a perspective opposite the overhead perspective captured by the first camera. In another example, the system can obtain a position of the end effector, wherein the robot inserting the first object into the second object is further based on the position of the end effector. The system can be configured to monitor and control forces associated with the end effector as the robot inserts the first object into the second object. After inserting the first object into the second object so as to define a successful insertion, the system can store the second image and the position of the end effector during the successful insertion. The system can also be configured to detect the successful insertion. In some examples, responsive to detecting the successful insertion, a success signal is sent to a reinforcement learning module so as to train the reinforcement learning module to learn an insertion path conditioned on the grasp offset and a location defined by the second object relative to the robot.

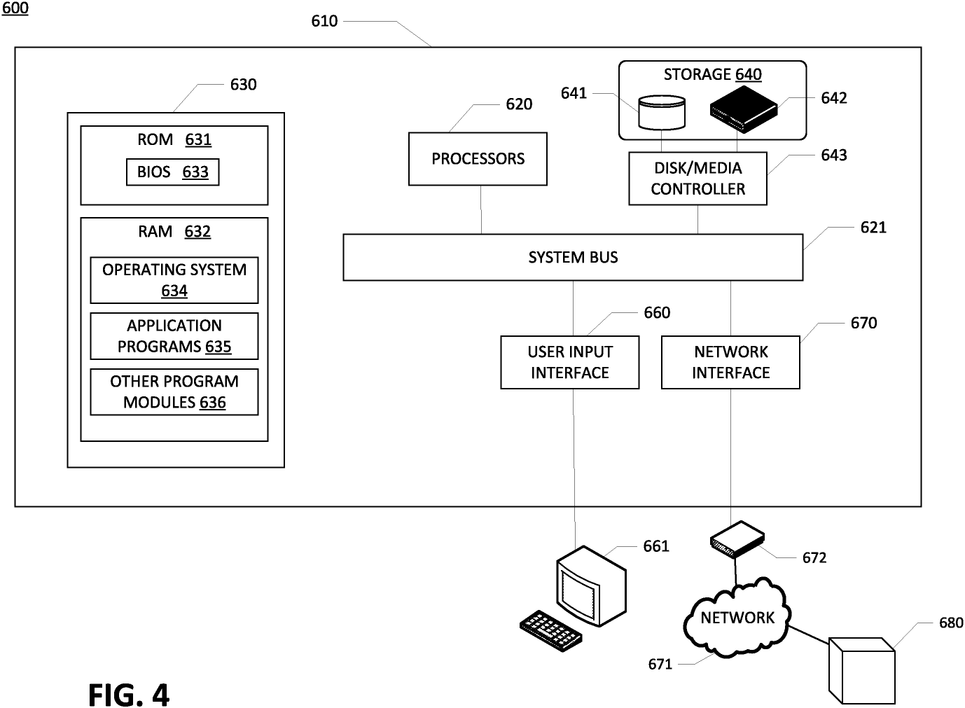

FIG. 4 illustrates an example of a computing environment within which embodiments of the present disclosure may be implemented. A computing environment 600 includes a computer system 610 that may include a communication mechanism such as a system bus 621 or other communication mechanism for communicating information within the computer system 610. The computer system 610 further includes one or more processors 620 coupled with the system bus 621 for processing the information. The autonomous systems 102, in particular the RL module 301, may include, or be coupled to, the one or more processors 620.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 4, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application programs 635, and other program modules 636. Application programs 635 may also include a user portal for development of the application program, allowing input parameters to be entered and modified as necessary.

The operating system 634 may be loaded into the memory 630 and may provide an interface between other application software executing on the computer system 610 and hardware resources of the computer system 610. More specifically, the operating system 634 may include a set of computer-executable instructions for managing hardware resources of the computer system 610 and for providing common services to other application programs (e.g., managing memory allocation among various application programs). In certain example embodiments, the operating system 634 may control execution of one or more of the program modules depicted as being stored in the data storage 640. The operating system 634 may include any operating system now known or which may be developed in the future including, but not limited to, any server operating system, any mainframe operating system, or any other proprietary or non-proprietary operating system.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610.

The computer system 610 may also include a field device interface 665 coupled to the system bus 621 to control a field device 666, such as a device used in a production line. The computer system 610 may include a user input interface or GUI 661, which may comprise one or more input devices, such as a keyboard, touchscreen, tablet and/or a pointing device, for interacting with a computer user and providing information to the processors 620.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium of storage 640, such as the magnetic hard disk 641 or the removable media drive 642. The magnetic hard disk 641 (or solid state drive) and/or removable media drive 642 may contain one or more data stores and data files used by embodiments of the present disclosure. The data store 640 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 610 operating in a networked environment using logical connections to one or more remote computers, such as remote computing device 680. The network interface 670 may enable communication, for example, with other remote devices 680 or systems and/or the storage devices 641, 642 via the network 671. Remote computing device 680 may be a personal computer (laptop or desktop), a mobile device, a server, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 680). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 4 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 610, the remote device 680, and/or hosted on other computing device(s) accessible via one or more of the network(s) 671, may be provided to support functionality provided by the program modules, applications, or computer-executable code depicted in FIG. 4 and/or additional or alternate functionality. Further, functionality may be modularized differently such that processing described as being supported collectively by the collection of program modules depicted in FIG. 4 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 4 may be implemented, at least partially, in hardware and/or firmware across any number of devices.

It should further be appreciated that the computer system 610 may include alternate and/or additional hardware, software, or firmware components beyond those described or depicted without departing from the scope of the disclosure. More particularly, it should be appreciated that software, firmware, or hardware components depicted as forming part of the computer system 610 are merely illustrative and that some components may not be present or additional components may be provided in various embodiments. While various illustrative program modules have been depicted and described as software modules stored in system memory 630, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of inserting a first object into a second object, the method comprising:
capturing a first image of the first object within a physical environment, the first object defining a mounting interface configured to insert into the second object;
based on the first image, a robot grasping the first object within the physical environment;
while the robot grasps the first object, capturing a second image of the first object, the second image including the mounting interface of the first object;
based on the second image of the first object, determining a grasp offset associated with the first object, the grasp offset indicating movement associated with the robot grasping the first object within the physical environment;
capturing an image of the second object; and
based on the grasp offset and the image of the second object, the robot inserting the first object into the second object.

2. The method as recited in claim 1, wherein the first object defines an electronic component, and the second object defines a printed circuit board.

3. The method as recited in claim 1, wherein capturing the first image of the first object further comprises:
capturing, by a first camera, the first image from an overhead perspective of the first object.

4. The method as recited in claim 3, the wherein the robot defines an end effector configured to grasp objects, and capturing the second image of the first object further comprises:
positioning the first object, by the robot, over a second camera; and
capturing, by the second camera, the second image from a perspective opposite the overhead perspective captured by the first camera.

5. The method as recited in claim 4, the method further comprising:
obtaining a position of the end effector, wherein the robot inserting the first object into the second object is further based on the position of the end effector.

6. The method as recited in claim 5, the method further comprising:
monitoring and controlling forces associated with the end effector as the robot inserts the first object into the second object.

7. The method as recited in claim 6, the method further comprising:
after inserting the first object into the second object so as to define a successful insertion, storing the second image and the position of the end effector during the successful insertion.

8. The method as recited in claim 7, the method further comprising:
detecting the successful insertion; and
responsive to detecting the successful insertion, sending a success signal to a reinforcement learning module so as to train the reinforcement learning module to learn an insertion path conditioned on the grasp offset and a location defined by the second object relative to the robot.

9. An autonomous system configured to assemble a printed circuit board (PCB) within a physical environment, the system comprising:
a first camera configured to:
capture a first image of an electronic component within the physical environment, the electronic component defining a mounting interface configured to insert into the PCB; and
capture a second image of the PCB within the physical environment;
a robot configured to, based on the first image, grasp the electronic component within the physical environment;
a second camera configured to capture a second image of the electronic component while the robot grasps the electronic component, the second image including the mounting interface of the electronic component;
a processor; and
a memory storing instructions that, when executed by the processor, cause the system to, based on the second image of the electronic component, determine a grasp offset associated with the electronic component, the grasp offset indicating movement associated with the robot grasping the electronic component within the physical environment,
wherein the robot is further configured to, based on the grasp offset and the image of the PCB, insert the electronic component into the PCB.

10. The autonomous system as recited in claim 9, wherein the first camera is further configured to capture the first image from an overhead perspective of the electronic component.

11. The autonomous system as recited in claim 9, wherein the robot defines an end effector configured to grasp objects, and the end effector is configured to position the electronic component over the second camera.

12. The autonomous system as recited in claim 11, wherein the second camera is further configured to capture the second image from a perspective opposite the overhead perspective captured by the first camera.

13. The autonomous system as recited in claim 12, the memory further storing instructions that, when executed by the processor, further cause the system to obtain a position of the end effector such that the robot is further configured to insert the electronic component into the PCB based on the position of the end effector.

14. The autonomous system as recited in claim 13, the memory further storing instructions that, when executed by the processor, further cause the system to monitor and control forces associated with the end effector as the robot inserts the electronic component into the PCB.

15. The autonomous system as recited in claim 14, the memory further storing instructions that, when executed by the processor, further cause the system to, after the electronic component is inserted into the PCB so as to define a successful insertion, store the second image and the position of the end effector during the successful insertion.

16. The autonomous system as recited in claim 1, the memory further storing instructions that, when executed by the processor, further cause the system to:
detect the successful insertion; and
responsive to detecting the successful insertion, send a success signal to a reinforcement learning module so as to train the reinforcement learning module to learn an insertion path conditioned on the grasp offset and a location defined by the PCB relative to the robot.
